(19) United States
(12) Patent Application Publication
(10) Pub. No.: US 2020/0406305 A1
(43) Pub. Date: Dec. 31, 2020

(54) PORTABLE POWER WASHER

(71) Applicant: Richard Beaman, Brooklyn, NY (US)

(72) Inventor: Richard Beaman, Brooklyn, NY (US)

(21) Appl. No.: 16/906,251

(22) Filed: Jun. 19, 2020

Related U.S. Application Data
(60) Provisional application No. 62/866,337, filed on Jun. 25, 2019.

(51) Int. Cl. B08B 3/02; B05B 11/00

(52) U.S. Cl. CPC B08B 3/028; B05B 11/0037; B05B 11/3052; B05B 11/0008; B05B 11/0078

(57) ABSTRACT

A portable pressure washer comprising a backpack a first tank, the first tank comprising a selectively removable cap and a quick connect, a second tank, the second tank comprising a selectively removable cap and a quick connect, at least one pump and a manifold coupled to the first tank, the second tank and the pump, wherein the first tank, the second tank and the manifold are configured to fit inside of a backpack.

### CROSS REFERENCE TO RELATED APPLICATIONS

This application is a non-provisional application that claims priority from U.S. Provisional Application Ser. No. 62/866,337 filed on Jun. 25, 2019, the disclosure of which is hereby incorporated by reference.

### BACKGROUND OF THE INVENTION

Portable power washers would be quite convenient for a user who wanted portability and movement while at the same time the ability to provide a pressurized spray of cleaning material. In addition that portability would be sufficient to allow a party who is of moderate size to carry the power washer.

### SUMMARY OF THE INVENTION

One embodiment of the invention relates to a portable power washer which is configured to be carried in a single backpack and which has a moderately powerful sprayer which is configured to spray a surface on demand.

In one embodiment the portable power washer includes a backpack and a plurality of tanks. The plurality of tanks includes at least one tank that includes water or an inexpensive liquid similar to water. Another tank would include a cleaning solution which is provided to be mixed with the water on a pre-set ratio. There would also be a manifold mixing tank and at least one pump or pressurizer configured to pressurize and mix the chemicals in the tank. There could also be a wand, and at least one tip for dispensing the solution.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1 is a side view of the embodiment showing the backpack and the tanks; and

FIG. 2 is another side view showing the backpack, the straps and the wand with a button.

FIG. 3 is another side view of the backpack;

FIG. 4 is an end view of the backpack; and

FIG. 5A shows a view of the manifold;

FIG. 5B shows a male and a female connection for a quick connect; and

FIG. 5C a female connector;

### DETAILED DESCRIPTION OF PREFERRED EMBODIMENTS

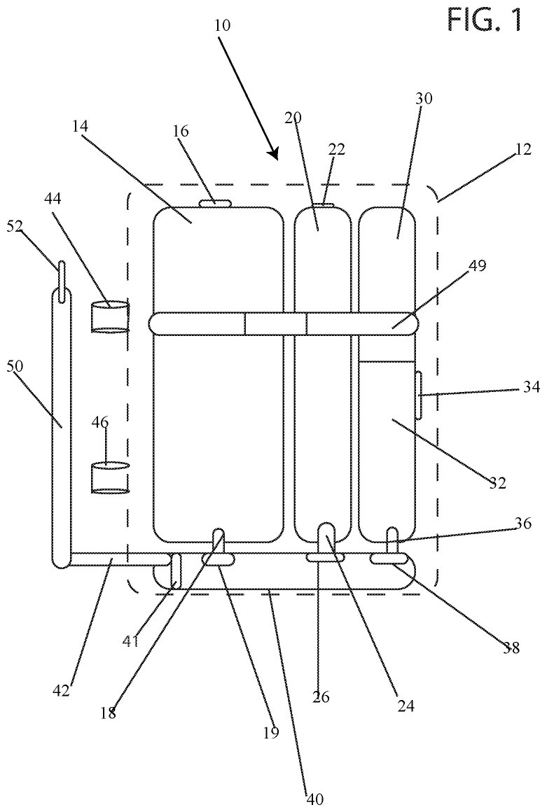

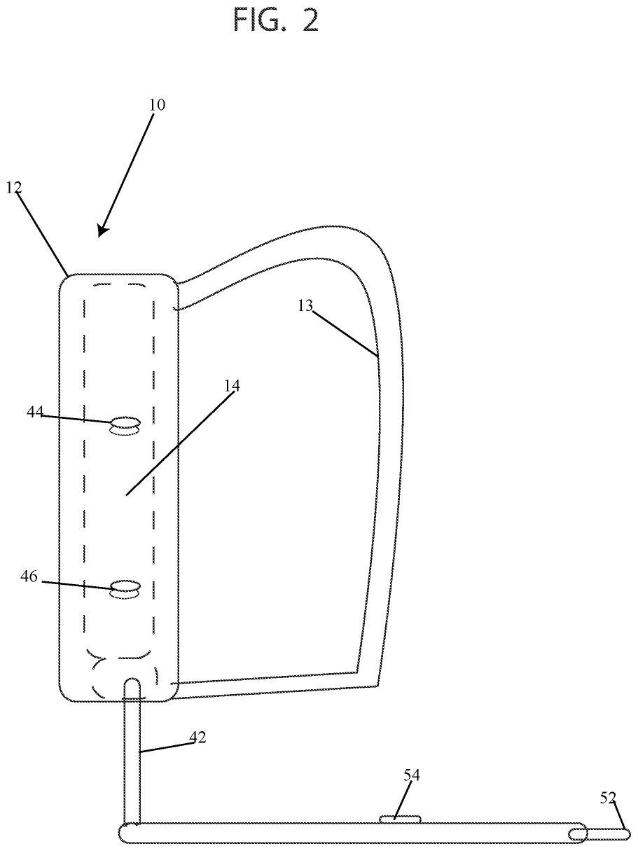

Referring to the drawings, FIG. 1 shows a first view of the embodiment wherein this first embodiment 10 includes a backpack 12, wherein the backpack 12 has straps 13 (See FIG. 2). Inside of the backpack 12 are a plurality of tanks. A first tank 14 is configured to hold water or a similar base solution. This tank has a cap 16 which is provided so that it can be selectively removed from the tank. At the opposite end of the tank is a quick connect connector 18. Positioned adjacent to the quick connect connector 18 is a valve 19. Valve 19 can be either upstream or downstream from quick connect connector 18. Valve 19 is configured as a one-way valve configured to selectively allow fluid to flow into manifold 40.

A second tank 20 is configured to hold a solution such as a cleaning solution that is configured to be mixed with the water. This cleaning solution can be any form of suitable cleaning solution such as an alcohol based solution, a soap based solution or some form of composite cleaning solution configured to mix with the water in the manifold such as manifold 40.

Tank 20 includes a cap 22 and a quick connect connector 24. In addition as described above there is also a valve 26 which is configured as a one-way valve which selectively allows fluid to flow from the second tank 20 to the manifold 40.

In addition there is also a battery 30 wherein the battery 30 is coupled to a pump 32 and is configured to provide power to the pump 32. Pump 32 is configured as an air pump which is configured to provide air pressure to the manifold to provide the mixture in the manifold with additional pressure so that the contents in the manifold can be distributed under pressure in relatively short bursts. Coupled to the pump 32 is an air intake 34 which is configured to take the air in under pressure and provide this pressurized air into the manifold. There is also an air valve 38 which is positioned between the pump and the manifold 40. The manifold is configured to take the water and the cleaning solution in under pressure and mix these components with the pressurized air so that these components can be distributed through the air water feed 42, and ultimately out to wand 50 when a valve 41 is opened. Coupled to backpack 12 are a plurality of straps 44 and 46 which are configured to hold wand 50 when wand 50 is not being used.

Wand 50 has a tip 52 to distribute the solution and a button 54 (See FIG. 2) which is configured to activate the pump 32 when pressed and to open up the respective valves such as valves 19, 26, 38, and 41 to allow fluid such as water, cleaning solution and air to flow into the manifold, and then ultimately out of the manifold by flowing through valve 41. The pressing of button 54 starts the pump 32 as well as opening these valves.

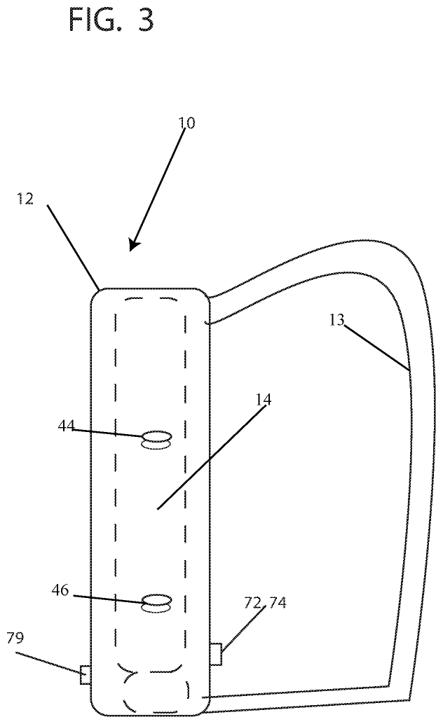

FIG. 3 shows a side view of this backpack 12 which is similar to that shown in FIG. 2 however in this embodiment, there is shown a side view wherein in this view there is a hinge 79 as well as clips 72,74 which allows the bottom of the backpack to be opened so that the containers, such as containers 14 and 30 can be quickly disconnected from the manifold 40.

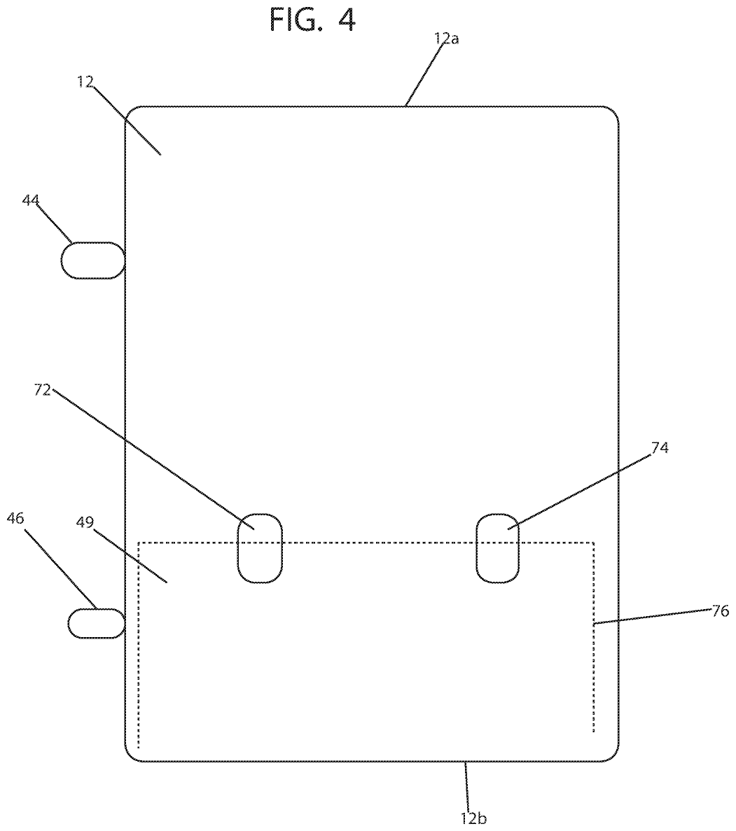

FIG. 4 shows a view of the backpack which shows the clips 72 and 74 which are used to secure the flap 49 of the backpack closed. Alternative to the clips 72 and 74 there can be a zipper 76 which can be selectively used to secure the bottom of the backpack closed. With this design with the bottom of the backpack being openable, the backpack can be opened from both the top end 12a and the bottom end 12b. With the opening at the bottom end the containers such as containers 14 and 30 can be disconnected from quick connects 18 and 24 respectively. Then by opening the top end 12a, the containers can be selectively lifted out from the backpack and then selectively filled up. The quick connect connection between the containers and the manifold can either be a quick connect snap on connection or

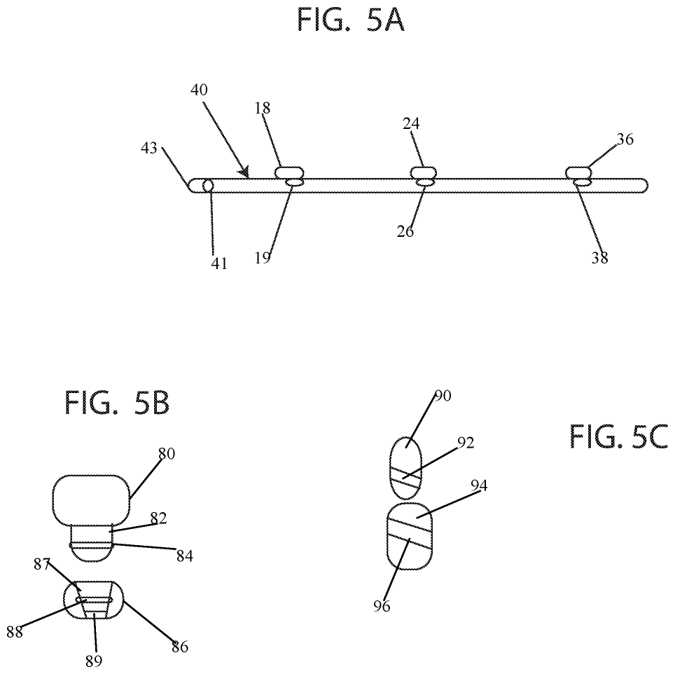

FIG. 5A shows a view of the manifold. The manifold 40 shows quick connects 18, 24, 36 and 43. In addition positioned adjacent to these quick connects are valves 41, 19, 26 and 38. These valves are configured to selectively allow fluid such as air, water or solution to flow into manifold 40 or out of manifold 40 through valve 41.

FIG. 5B shows a male and a female connection for a quick connect with this design the male quick connect 80 can be connected to any device such as the manifold or to the container. Also the female quick connect 86 can be connected to either the container or to the manifold 40. For example, male connector has a stem 82 with a rim 84. Female connector has a body 86, an opening 87, a rim 88, and a second opening 89. The male stem 82 fits inside of the opening 87 such that rim 84 locks with rim 88 to form a secure air locked connection.

Alternatively, shown in FIG. 5C a female connector 94 can have threads 96 which are configured to receive threads 92 of a male connector 90. Either one of the female or the male connectors can be connected to the manifold 40 or to the respective container as is suitable.

Ultimately this design results in a simple and portable pressure washer which is configured to allow a user to move freely such as on a sidewalk and also freely distribute the water and cleaning solution under pressure. The amount of pressure needed and the amount of water or cleaning solution is generally not that high for many tasks such as cleaning a sidewalk, windows or other surfaces. One use for this washer could be to clean a localized area such as an area which has received animal waste in a small targeted area.

Accordingly, while at least one embodiment of the present invention have been shown and described, it is to be understood that many changes and modifications may be made thereunto without departing from the spirit and scope of the invention as defined in the appended claims.

What is claimed is:

1. A portable pressure washer comprising:
a) A backpack;
b) A first tank, the first tank comprising a selectively removable cap and a quick connect;
c) A second tank, the second tank comprising a selectively removable cap and a quick connect;
d) At least one pump;
e) A manifold coupled to the first tank, the second tank and the pump;
wherein the first tank, the second tank and the manifold are configured to fit inside of a backpack.

2. The portable pressure washer as in claim 1, further comprising at least one valve positioned between the first tank and the manifold.

3. The portable pressure washer as in claim 1, further comprising at least one valve positioned between the first tank and the manifold.

4. The portable pressure washer as in claim 1, further comprising at least one valve positioned between the pump and the manifold.

5. The portable pressure washer as in claim 1, further comprising at least one wand coupled to the manifold.

6. The portable pressure washer as in claim 5, further comprising at least one valve coupled between the manifold and the wand.
